(19) United States
(12) Patent Application Publication
(10) Pub. No.: US 2026/0063174 A1
(43) Pub. Date: Mar. 5, 2026

(54) DEVICE MOUNTABLE IN A HOLLOW SENSORIZED ROLLER AND ASSOCIATED HOLLOW SENSORIZED ROLLER AND ROLLER BEARING

(71) Applicant: AKTIEBOLAGET SKF, GOTEBORG (SE)

(72) Inventors: Andreas Clemens VAN DER HAM, Warnsveld (NL); Kishor Kamalakar POWAR, Bangalore (IN); Alexandre André Roland TAILLEPIED, Fondettes (FR)

(21) Appl. No.: 19/312,674

(22) Filed: Aug. 28, 2025

(30) Foreign Application Priority Data
Sep. 4, 2024 (IN) 202441067014

(51) Int. Cl. F16C 41/00; F16C 19/36

(52) U.S. Cl. CPC F16C 41/00; F16C 19/364; F16C 2233/00

(57) ABSTRACT

A sensorized roller for a rolling bearing includes a roller body having a central axial through bore and a device fitted in the axial central through bore. The device includes a power module having a cylindrical body having a first end cap, the cylindrical body extending into a first end of the axial through bore of the roller body. The device also includes a second end cap having a cylindrical body inserted into a second end of the axial through bore of the roller body. A first annular sealing element is interposed between the cylindrical body of the power module and the axial central through bore of roller body, and a second annular sealing element is interposed between the cylindrical body of the second end cap and the axial central through bore of the roller body.

### CROSS-REFERENCE

This application claims priority to Indian patent application no. 202441067014 filed on September 4, 2025, the contents of which are fully incorporated herein by reference.

### TECHNOLOGICAL FIELD

The present disclosure is directed to the monitoring of rolling bearings and more particularly to a hollow sensorized roller for monitoring a rolling bearing and a device mountable in the hollow sensorized roller.

### BACKGROUND

It is known to provide a sensorized roller in a rolling bearing to perform condition monitoring of the rolling bearing. The sensorized roller comprises a housing enclosing a sensor module including measurement devices for measuring deformation of the roller and electronics for processing a deformation signal from the measuring devices, and an antenna for wirelessly transmitting the processed deformation signal to an external receiver.

To supply power to the measurement devices, the housing further encloses a harvesting module to generate power from movements of the roller and provide the power to the measurement devices. The harvesting module comprises an electrical generator generating electrical power from the rotation of the sensorized roller.

In order to ensure proper functioning of the sensorized roller, the hollow sensorized roller has to be hermetically sealed to protect the measurement devices and the electrical generator from the ingress of grease, oil and other contaminants.

### SUMMARY

An aspect of the present disclosure is a hermetically sealed hollow sensorized roller wherein the harvesting module is robustly secured to the module.

According to an aspect of the disclosure, a hollow sensorized roller for a rolling bearing is provided. The hollow sensorized roller comprises a roller body having an axial central through bore and a housing fitted within the axial central through bore of the roller.

The housing comprises a power module and an end part. The power module comprises an end cap and the end part comprises an end cap inserted into a first end of the axial central through bore of the roller body. The end part comprises an end cap inserted into a second end of the axial central through bore of the roller body. A first annular sealing element is interposed between the end cap of the power module and the axial central through bore of the roller body, and a second annular sealing element interposed between the end cap of the end part and the axial central through bore of the roller body.

The housing is hermetically seals in the roller body so that the electronics of the sensor module are protected from the ingress of grease, oil and other contaminants to ensure the reliability and to increase the operational life of the hollow sensorized roller.

Further, the arrangement of the sealing elements interposed between the end cap of the end caps and the roller body limits the axial and radial movements of the power module and the end part in the roller body so that a relative movement between the housing and the roller body is limited.

Preferably, the end cap of the power module comprises a cylindrical body and an end portion extending radially outward the cylindrical body, the first annular sealing element being radially interposed between the cylindrical body of the end cap and the axial central through bore of the roller body and axially interposed between the end portion of the end cap and the axial central through bore of the roller body. Advantageously, a groove is formed onto the cylindrical body of the end cap, the first annular sealing element being located partly inside the groove.

Preferably, a first end of the axial central through bore of the roller body comprises a conical portion and the end portion of the end cap of the power module is conical and inserted in the conical portion.

Advantageously, the end cap of the end part comprises a cylindrical body and an end portion extending radially outward the cylindrical body, the second annular sealing element being radially interposed between the cylindrical body of the end part and the axial central through bore of the roller body and axially interposed between the end portion of the end cap of the end part and the axial central through bore of the roller body. Advantageously, a groove is formed onto the cylindrical body of the end cap of the end part, the second annular sealing element being located partly inside the groove.

Preferably, a first end of the axial central through bore of the roller body comprises a conical portion and the end portion of the end cap is conical and inserted in the conical portion.

Preferably, the hollow sensorized roller further comprises a sensor module including a tubular housing and an adapter supporting the power module and the sensor module, the end part being secured to the sensor module.

A further aspect of the disclosure comprises a sensorized roller for a rolling bearing that includes a roller body having a central axial through bore and a device fitted in the axial central through bore. The device comprises a power module comprising a cylindrical body having a first end cap, the cylindrical body extending into a first end of the axial through bore of the roller body. The device also includes a second end cap including a cylindrical body inserted into a second end of the axial through bore of the roller body. A first annular sealing element is interposed between the cylindrical body of the power module and the axial central through bore of roller body, and a second annular sealing element is interposed between the cylindrical body of the second end cap and the axial central through bore of the roller body.

Advantageously, the hollow sensorized roller further comprises anti-rotation means, the adapter being provided with a front face in axial contact with a first end of the tubular housing of the sensor module and with a mounting base onto which is mounted the end cap of the power module, the anti-rotation means being supported by the front face of the adapter and being inserted into the tubular housing of the sensor module to avoid a rotation of the housing relative to the adapter.

According to another aspect, a rolling bearing is proposed. The rolling bearing comprises a stationary first ring and a rotatable second ring configured to rotate concentrically relative to one another, and at least one row of rolling elements interposed between a first raceway and a second raceway respectively provided on the first and second rings, one rolling element being a hollow sensorized roller as defined above.

### BRIEF DESCRIPTION OF THE DRAWINGS

Other advantages and features of the disclosure will appear on examination of the detailed description of embodiments, in no way restrictive, and the appended drawings in which:

FIG. 1 is a sectional view of a roller bearing according to an embodiment of the present disclosure.

FIG. 2 is an exploded perspective view of a hollow sensorized roller according to an embodiment of the disclosure.

FIG. 3 is a perspective view, partly in section, of a housing of the hollow sensorized roller of FIG. 2.

FIG. 4 is a sectional elevation view of the hollow sensorized roller of FIG. 2.

FIG. 5 is a longitudinal cross sectional view of a power module housed in the sensorized roller of FIG. 2.

FIG. 6 is a partial perspective view of a second end of the housing of the sensorized roller of FIG. 2.

FIG. 7 is a longitudinal cross sectional view of the second end of the housing of the sensorized roller of FIG. 2.

FIG. 8 is a longitudinal cross section of an example of an end part and the sensor module housed in sensorized roller of FIG. 2.

FIGS. 9 and 10 are first and second perspective views of an adapter of the housing in FIGS. 3 and 4.

### DETAILED DESCRIPTION

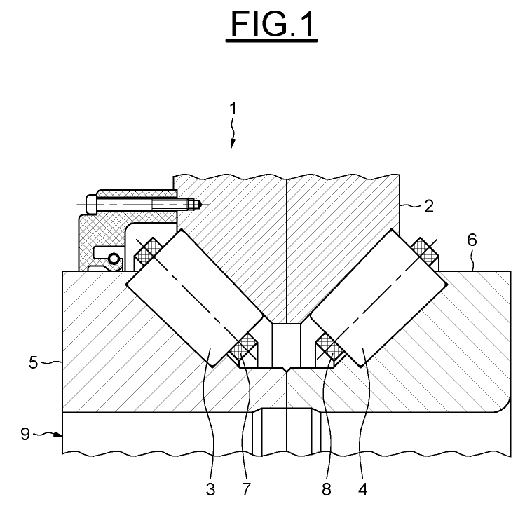

Reference is made to FIG. 1 which represents schematically an example of a roller bearing 1.

The bearing 1 is a tapered roller bearing and comprises an outer ring or stationary ring 2 having conical first and second outer raceways for a first row 3 and a second row 4 of rolling elements comprising tapered rollers. The bearing further comprises a rotatable ring having a first inner ring 5 and an axially adjacent second inner ring 6 that have first and second inner raceways, respectively for the first and second roller rows 3, 4. In addition, the bearing 1 further comprises a first cage 7 and a second cage 8 for retaining the rollers of the first and second roller sets respectively. Typically, the cages may be formed from segments that abut each other in circumferential direction.

To provide the necessary stiffness and ensure a long service life, the bearing is preloaded. The axial position of the rotatable rings 5, 6 relatives to the stationary ring 2 is set such that the first and second roller sets 2, 4 have a negative internal clearance.

In variant, the bearing 1 is a spherical roller bearing or a cylindrical roller bearing and is not preloaded.

In the depicted bearing, at least one of the rolling elements in either of the first and second roller rows 3, 4 is replaced with a hollow sensorized roller. A shaft 9 is surrounded and fixed to the rotatable rings 5, 6. The rolling bearing 1 comprises tapered rollers. In another embodiment, the rolling bearing 1 may comprise other type of rolling elements, for example cylindrical rollers or spherical rollers. The rolling bearing 1 may also comprise only one row of rolling elements or more than two rows of rolling elements, the number of cages being determined according to the number of rows.

The rolling bearing 1 comprising a row of rolling elements comprises a unique inner ring. In another embodiment, the outer ring 2 is the rotatable ring and the inner rings 5, 6 are the stationary rings.

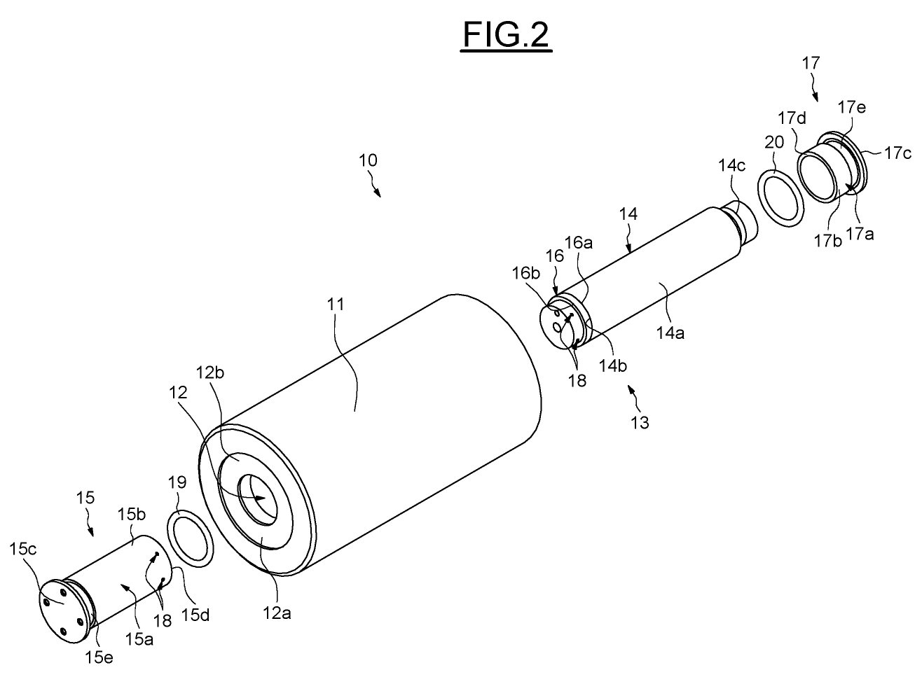

FIG. 2 illustrates schematically an example of the hollow sensorized roller 10. The hollow sensorized roller 10 comprises a roller body 11 comprising a axial central through bore 12 and a device 13 within the central through bore 12 that extends through the roller body 11.

Each end of the axial central through bore 12 comprises an axial centering portion 12a, a conical portion 12b and a radial shoulder 12c. The conical portion 12b extends obliquely outward from a first end of the centering portion 12a and the radial shoulder 12c extends radially inwards from a second end of the centering portion 12a.

The device 13 comprises a sensor module 14, a power module 15, an adapter 16 connecting the power module 15 to the sensor module 14, and an end part 17.

The sensor module 14 comprises a tubular housing 14a, and the power module 15 comprises a body 15a inserted into a first end of the bore 12 of the roller body 11. A first annular sealing element 19 is interposed between the body 15a of the power module 15 and the bore 12 of the roller body 11. The sensor module 14 is formed from two semi-cylindrical housing halves which are held together axially by the end cap 17 and the adapter 16. Screws and dowel pins (not represented) connect together radially the two semi-cylindrical housing halves.

The sensor module 14 houses at least one sensor (not represented on FIG. 2) for measuring parameters relating to the condition of the hollow sensorized roller. The sensor 14 is secured to the tubular housing 14a of the sensor module 14 and comprises, for example, a load sensor for measuring a load distribution across the hollow sensorized roller.

The sensor module 14 further houses an antenna (not represented) secured to the tubular housing 14a of the sensor module 14. The sensor module 14 may further house a wireless transmitter (not represented) connected to the antenna to transmit the measurements of the sensor to a processing device (not represented) located outside the bearing for processing the measurements.

The body 15a of the power module 15 comprises a cylindrical body 15b and an end cap 15c (first end cap) extending radially outward from the cylindrical body 15b. The first annular sealing element 19 is radially interposed between the cylindrical body 15b of the body 15a and the bore 12 of the roller body 11 and axially interposed between the end cap 15c of the body 15a and the bore 12 of the roller body 11.

The adapter 16 has a central portion 16a in axial contact with a first end 14b of the housing 14a of the sensor module 14. The adapter 16 also includes a mounting base 16b onto which is mounted a first end 15d of the cylindrical body 15b of the body 15a of the power module 15. The end cap 15c of the body 15a is secured to or integrally formed with the second end of the cylindrical body 15b of the body 15a.

A groove 15e is formed on the cylindrical body 15b of the body 15a of the power module 15. The first annular sealing element 19 is located partly inside the groove 15e.

The device 13 further comprises anti-rotation means (end portion) supported by the central portion 16a of the adapter 16 and insertable into the tubular housing 14a of the sensor module 14 to avoid a rotation of the tubular housing 14a relative to the adapter 16.

The device 13 further comprises fixing means 18 to secure the mounting base 16b and the first end 15b of the body 15a of the power module 15.

The end part 17 comprises an end cap 17a (second end cap) inserted into a second end of the bore 12 of the roller body 11. A second annular sealing element 20 is interposed between the end cap 17a of the end part 17 and the bore 12 of the roller body 11. The end cap 17a of the end part 17 comprises a cylindrical body 17b and an end portion 17c extending outwards the cylindrical body 17b.

The second annular sealing element 20 is radially interposed between the cylindrical body 17b of the end part 17 and the bore 12 of the roller body 11 and axially interposed between the end portion 17c of the end cap 17a of the end part 17 and the bore 12 of the roller body 11. A first end 17d of the cylindrical body 17b of the end cap 17a of the end part 17 is secured to a second end 14c of the tubular housing 14c of the sensor module 14.

The cylindrical body 17b of the end cap 17a of the end part 17 may be clipped on the end 14c of the tubular housing 14a of the sensor module 14. A groove 17e is formed onto the cylindrical body 17b of the end cap 17a of the end part 17. The second annular sealing element 20 is located partly inside the groove 17e.

The device 13 as a whole is shaped to fit within the roller bore 12 and is mounted to and located in the bore 12 by means of the first and second sealing elements 19, 20.

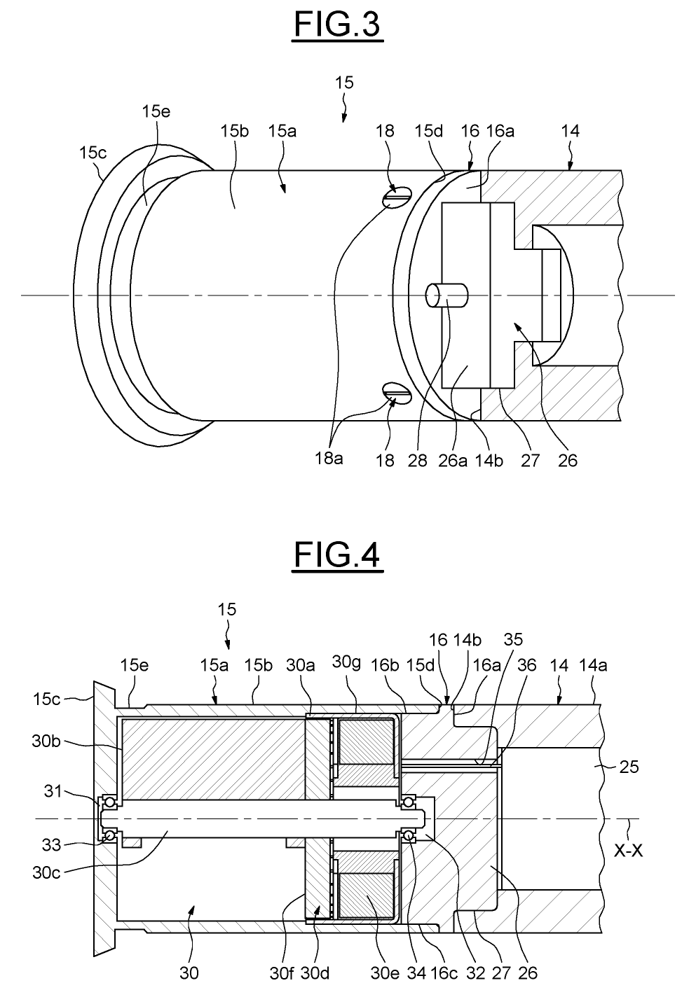

FIGS. 3 and 4 illustrate respectively a partial view and a longitudinal cross section of an example of the sensor module 14 and the power module 15 and the adapter 16 therebetween. The sensor and antenna housed in the sensor module 14 are represented on FIG. 4 and referenced 25.

The anti-rotation means comprise a non-circular end part 26 protruding relative to the central portion 16a of the adapter 16 and supported by the central portion 16a of the adapter 16. The first end 14b of the sensor module 14 includes an aperture 27 having a shape complementary to the shape of the non-circular end part 26. The non-circular end part 26 is insertable into the non-circular aperture 27 to prevent rotation of the housing 14a of the sensor module 14 relative to the adapter 16. The non-circular end part 26 may be rectangular, triangular, square, hexagonal, star shaped or another shape so that the adapter 16 does not rotate relative the housing 14a of the sensor module 14.

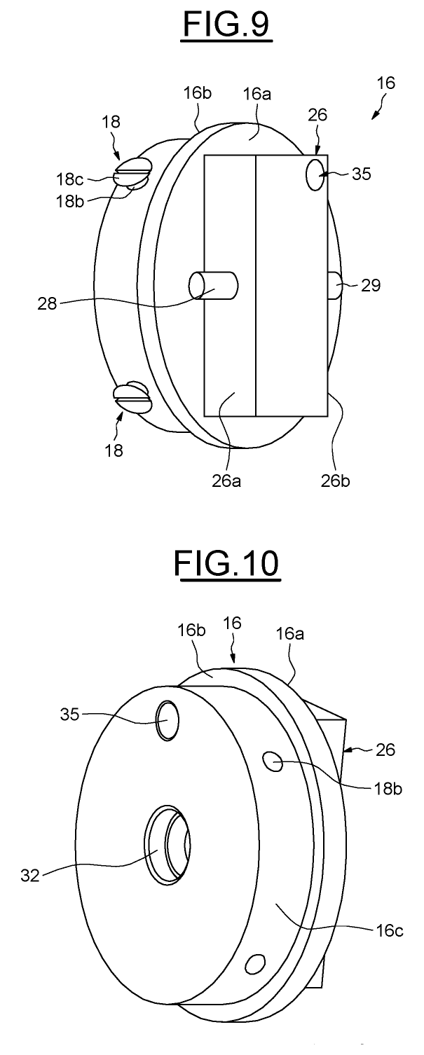

The device 13 further comprises securing means to axially secure the adapter 16 and the first end 14b of the housing 14a of the sensor module 14. The securing means comprises at least first and second pins 28, 29 supported by the non-circular end part 26. A first end of the first pin 28 is inserted into a first lateral face 26a of the non-circular end part 26 and a first end of the second pin 29 being inserted into a second lateral face 26b of the non-circular end part 26. The second lateral face 26b of the non-circular end part 26 is opposed to the first lateral face 26a of the non-circular end part 26. The second end of the first and second pins 28, 29 is inserted into the tubular housing 14a of the sensor module 14. The second pin 29 and the second lateral face 26b of the non-circular end part 26 are represented in FIG. 9.

The power module 15 may house an energy harvester. The energy harvester comprises, for example, an electrical generator 30 having an axis along a longitudinal axis X-X of the hollow sensorized roller 10. The electrical generator 30 produces energy using the rotation of the hollow sensorized roller 10.

The electrical generator 30 comprises a stator 30a rigidly fixed to the cylindrical body 15b of the body 15a of the power module 15, an eccentric mass or weight 30b rigidly fixed to a main shaft 30c having an axis along the first axis X-X, a rotor 30d fixed to the shaft 30c and a stator coil 30e mounted in the stator 30a and configured to be rotated by the rotation of the hollow sensorized roller 10. The stator coil 30e forms one single stator pole. The rotor 30d comprises a magnetic ring 30f comprising for example permanent magnets.

The eccentric mass 30b is driven by gravity G and centrifugal force to maintain the main shaft 30c of the generator 30 when rotation of the hollow sensorized roller 10 along the first rotation axis X-X. The rotation of the hollow sensorized roller drives the rotation of the stator 30a and thus the stator coil 30e of the generator 30.

The stator 30a is located between the rotor 30d and the mounting base 16b. The stator 30 may comprise flux guides 30g surrounding the rotor 30d to guide the magnetic flux. The passage of the magnetic ring 30f in front of the flux guides 30g generates an electromotive force between the ends of the coil 30e.

The power generated by the electric generator 30 depends on the magnetic flux going through the coil 30e. The flux guides 30g concentrate and guide the magnetic flux of the rotor 30d through the stator coil 30e of the stator 30a so that the stator coil 30e generates a higher electromotive force. The flux guides 30g redirect axially all the magnetic flux of the magnetic ring 30f so that the magnetic flux passes through the stator coil 30e.

The electrical generator 30 is a claw pole generator. In variant, the electrical generator 30 may comprise a plurality of stator poles, the generator 30 being for example a multi-pole brushless DC electric motor BLDC. The electrical generator 30 may be another kind of generator.

The end cap 15c of the power module 15 includes a first bore 31 housing a first bearing 33, and the mounting base 16b of the adapter 16 includes a second bore 32 housing a second bearing 34, the first and second bearings 33, 34 rotatably support the main shaft 30c of the electrical generator 30.

The first and second bearings 33, 34 limit axial and radial displacements of the main shaft 30c thereby reducing the airgap between the magnetic ring 30f and the flux guides 30g. The limitation of the axial and radial displacements of the main shaft 30c further prevents collisions between the magnetic ring 30f and the flux guides 30g and prevents collisions between the eccentric mass 30b and the tubular housing 15a of the power module 15. The first and second bearings 33, 34 may comprise deep groove ball bearings.

The adapter 16 further comprises an axial through-hole 35 inside which a wire 36 passes through to electrically connect the power module 15 and the sensor module 14. As the power module 15 and the sensor module 14 are secured together in such a manner that the power module 15 cannot rotate relative to the sensor module 14, the wire 32 cannot be damaged.

The end cap 15c of the body 15a may be conical. Similarly, the end portion 17c of the end cap 17a of the end part 17 may be conical.

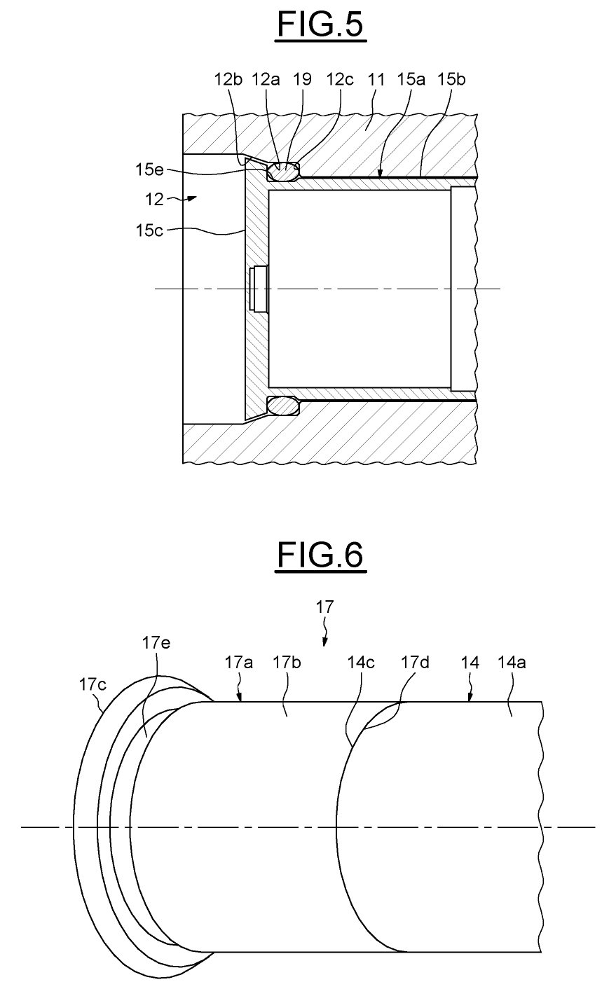

FIG. 5 illustrates a longitudinal cross section of an example of the power module 15 housed in the roller body 11. The first sealing element 19 hermetically seals the power module 15 in the roller body 11. The first sealing element 19 is radially interposed between the groove 15e of the body 15a of the power module 15 and the centering portion 12a of the first end of the axial central through bore 12 of the roller body 11. The first sealing element 19 is axially interposed between the end cap 15c of the body 15a of the power module 15 and the radial shoulder 12c of the first end of the axial central through bore 12 of the roller body. Further, the arrangement of the first sealing element 19, the end cap 15c of the body 15a and the groove 15e of the body 15a limits the axial and radial movements of the power module 15 in the roller body 11.

The end cap 15c of the body 15a of the power module 15 is conical and inserted in the conical portion 12b of the axial central through bore 12 so that the smallest base of the conical end cap 15c of the body 15a of the power module 15 is in contact with the first sealing element 19. The conical end cap 15c is housed in the conical portion 12b. The arrangement of the conical end cap 15c and the conical portion 12b further limits the axial and radial movements of the power module 15 in the roller body 11.

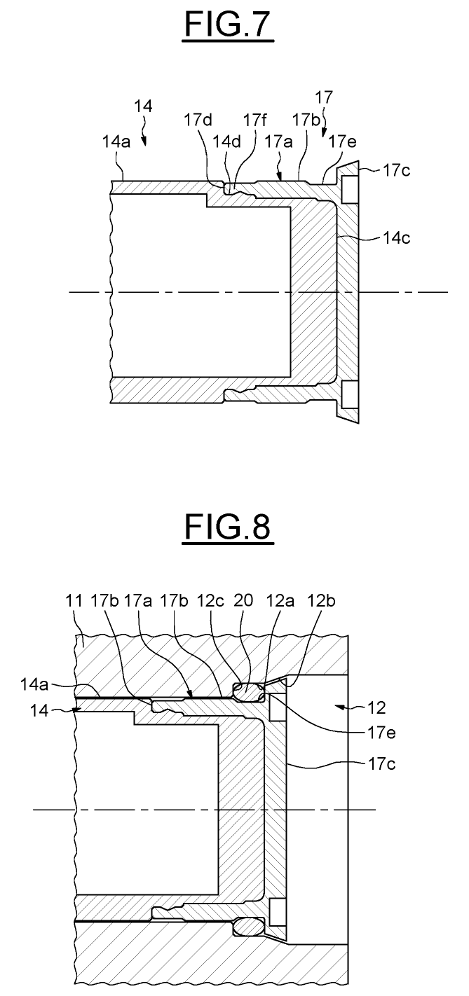

FIGS. 6 and 7 illustrate respectively a partial view and a longitudinal cross section of an example of the sensor module 14 and the end part 17. In the example, the cylindrical body 17b of the end cap 17a of the end part 17 is clipped on the end 14c of the tubular housing 14a of the sensor module 14. The end 14c of the tubular housing 14a of the sensor module 14 includes a groove 14d, and the cylindrical body 17a of the end part 17 includes a tip 17f clipped into the groove 14d of the sensor module 14.

FIG. 8 are a longitudinal cross section of an example of the sensor module 14 and the end part 17 housed in the roller body 11. The second sealing element 20 hermetically seals the end part 17 in the roller body 11. The second sealing element 20 is radially interposed between the groove 17e of the end cap 17a of the end part 17 and the centering portion 12a of the second end of the axial central through bore 12 of the roller body. The second sealing element 20 is axially interposed between the end portion 17c of the end cap 17a of the end part 17 and the radial shoulder 12c of the second end of the axial central through bore 12 of the roller body 11. Further, the arrangement of the second sealing element 20, the end portion 17c of the end cap 17a and the groove 17e of the end cap 17a limit the axial and radial movements of the end part 17 in the roller body 11.

The end portion 17c of the end cap 17a of the end part 17 is conical and inserted in the conical portion 12b of the axial central through bore 12 so that the smallest base of the conical end portion 17c of the end cap 17a of the end part 17 is in contact with the second sealing element 20. The conical end portion 17c is housed in the conical portion 12b. The arrangement of the conical end portion 17c and the conical portion 12b further limit the axial and radial movements of the end part 17 in the roller body 11.

FIGS. 9 and 10 are views of the example of adapter 16 illustrated in FIGS. 3 and 4. The mounting base 16b of the adapter 16 comprises a circumferential surface 16c onto which is mounted the body 15a of the power module 15. The fixing means 18 comprise a first set of through-holes 18a in a lateral face of the body 15a of the power module 15 (represented in FIG. 3), a second set of holes 18b in the circumferential surface 16c and a plurality of screws 18c. Each screw 18c passes through one of the through-holes 18a of the first set and being engaged in one of the holes 18b of the second set. The adapter 16 permits to robustly secure the power module 15 to the sensor module 14 in a removable manner and to simplify the mounting of the hollow sensorized roller 10.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sensorized rollers.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A sensorized roller for a rolling bearing, comprising:
a roller body having a central axial through bore and a device fitted in the axial central through bore, the device comprising:
a power module comprising a cylindrical body having a first end cap, the cylindrical body extending into a first end of the axial through bore of the roller body,
a second end cap including a cylindrical body inserted into a second end of the axial through bore of the roller body,
a first annular sealing element interposed between the cylindrical body of the power module and the axial central through bore of roller body, and
a second annular sealing element interposed between the cylindrical body of the second end cap and the axial central through bore of the roller body.

2. The sensorized roller according to claim 1,
wherein the first annular sealing element is axially interposed between the first end cap and a shoulder of the roller body at the first end of the axial through bore.

3. The sensorized roller according to claim 2,
wherein the cylindrical body of the power module includes a groove, and
wherein the first annular sealing element is at least partially disposed in the groove.

4. The sensorized roller according to claim 2,
wherein the first end of the axial central through bore of the roller body includes a conical portion, and
wherein a conical portion of the first end cap abuts against the conical portion of the first end of the axial central through bore.

5. The sensorized roller according to claim 1,
wherein the second end cap includes a radially enlarged end portion,
wherein the second annular sealing element is radially interposed between the cylindrical body of the second end cap and the axial central through bore of the roller body, and
wherein the second annular sealing element is axially interposed between the radially enlarged end portion of the second end cap and a shoulder of the roller body at the second end of the axial through bore.

6. The sensorized roller according to claim 5,
wherein the cylindrical body of the second end cap includes a groove, and
wherein the second annular sealing element is at least partially disposed in the groove of the second end cap.

7. The sensorized roller according to claim 6,
wherein second end of the axial central through bore of the roller body includes a conical portion, and
wherein a conical portion of the second end cap abuts against the conical portion of the second end of the axial central through bore.

8. The sensorized roller according to claim 1,
further comprising a sensor module including a tubular housing and an adapter connecting the power module and the sensor module,
wherein the second end cap is mounted on an end of the sensor module.

9. The sensorized roller according to claim 8,
wherein the adapter includes a mounting base, a central portion and an end portion,
wherein the end portion comprises a projection, and
wherein the sensor module incudes a non-circular opening in which the projection is mounted to prevent relative rotation between the adapter and the sensor module.

10. A rolling bearing comprising:
a stationary first ring,
a rotatable second ring configured to rotate concentrically relative to the first ring, and
at least one row of rollers interposed between a first raceway of the stationary ring and a second raceway of the second ring,
wherein one of the rollers is a sensorized roller according to claim 1.
